(19) United States
(12) Patent Application Publication
(10) Pub. No.: US 2003/0206133 A1
(43) Pub. Date: Nov. 6, 2003

(54) Geochronicle based identification for e-business

(75) Inventor: Ting Dean Cheng, Mahopac, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 09/862,732

(22) Filed: May 22, 2001

(51) Int. Cl. G01S 5/14

(52) U.S. Cl. 342/357.06

(57) ABSTRACT

A method and system for generating and processing object identifiers in an e-commerce environment. The system comprises a database for holding objects; at least one identification system for providing unique identifiers for objects, wherein the identification system obtains location and time information from a global positioning system (GPS) and encodes the location and time information into each unique identifier; and an application for processing the objects, wherein the application includes a system for processing the unique identifier.

### BACKGROUND OF THE INVENTION

1. Technical Field

The present invention relates generally to providing identifiers, and more particularly relates to a universal system and method for providing unique identifiers to objects in an e-business environment using a global positioning system (GPS).

2. Related Art

Providing unique and persistent identifiers to hardware, software, files, data, email messages, events, etc., (collectively referred to herein as objects) remains an ongoing challenge. This is particularly the case in large expanding network and e-commerce environments, such as the Internet and World Wide Web (hereinafter, “web”). In particular, as the web expands, it becomes more and more difficult to ensure that different objects do not share the same name or identifier. Ensuring uniqueness is critical for technologies that deal with sorting, searching, indexing, storing and cataloging information regarding such objects.

While it is fairly straightforward to implement a system that guarantees a unique naming convention for objects created within a limited space and time, it becomes almost impossible to guarantee uniqueness worldwide over an unlimited time frame. For example, it is fairly straightforward for a division of a large corporation located in the United States to institute a naming convention for their hardware devices and software releases. However, it may not be so simple to ensure that another division of the corporation in another part of the world will, or can abide by the same convention. The problem becomes even more difficult, for instance, when different entities are involved, when entities split or merge, or when new technologies are introduced.

In PCT application number PCT/US99/15337, entitled Retinal Vasculature Image Acquisition Apparatus and Method, by Golden, et al., published on Jan. 20, 2000, a system for tracking animals by combining retinal scan information with GPS information is provided. Unfortunately, this disclosure, which is hereby incorporated by reference, is limited to tracking the movement of livestock.

Accordingly, a need exists for a system and method of generating unique and persistent identifiers for inanimate objects, particularly those that exist in an e-commerce environment.

### SUMMARY OF THE INVENTION

The present invention overcomes the above-mentioned limitations, as well as others, by providing a system and method for generating unique and persistent identifiers using information obtained from a global positioning system (GPS).

In a first aspect, the invention provides a system for assigning object identifiers, comprising: a global positioning system (GPS) receiver for providing location and time information; an identification generator that generates an identifier, wherein the identifier includes the provided location and time information in an encoded format; and a system for assigning the identifier to an object located proximate the GPS receiver.

In a second aspect, the invention provides a program product stored on a recordable medium for assigning object identifiers, comprising: means for receiving location and time information from a global positioning system (GPS) receiver; means for generating an identifier, wherein the identifier includes the received location and time information in an encoded format; and means for outputting the identifier in a format suitable for tagging an object located proximate the GPS receiver.

In a third aspect, the invention provides a system for processing object identifiers in an e-commerce environment, comprising: a database for holding objects; at least one identification system for providing unique identifiers for objects, wherein the identification system obtains location and time information from a global positioning system (GPS) and encodes the location and time information into each unique identifier; and an application for processing the objects, wherein the application includes a system for processing the unique identifier.

In a fourth aspect, the invention provides a method of generating object identifiers, comprising the steps of: obtaining time and location information from a global positioning system (GPS); generating a unique identifier from the time and location information, wherein the time and location information is encoded into the unique identifier; and associating the unique identifier with an object.

### BRIEF DESCRIPTION OF THE DRAWINGS

The preferred exemplary embodiment of the present invention will hereinafter be described in conjunction with the appended drawings, where like designations denote like elements, and:

FIG. 1 depicts an e-commerce environment utilizing an object identifier system in accordance with the invention.

FIG. 2 depicts a system for assigning unique object identifiers in accordance with the invention.

### DETAILED DESCRIPTION OF THE INVENTION

According to the present invention, unique and persistent identifiers, or ID's, for tagging objects are generated based on information obtained from a global positioning system (GPS). An “object,” for the purposes of this invention, may include, for example, things, data, files, messages, software, hardware, events, transactions, etc. Uniqueness is achieved based on the differences in time and location of observed phenomena as the phenomena occur in our four dimensional world. In particular, the invention binds both temporal (i.e., time dimension) and geographical (i.e., location dimension) information with objects. For instance, such information may include the time and place where an object was created, transformed, or recorded. With the use of a GPS receiver, the information can be readily obtained and converted into a unique identifier.

The twenty four GPS satellites were deployed in such a way that at least four satellites are electronically visible at any time and any place on the earth. GPS relies on “L” band radio waves for each satellite to broadcast the parameters of the location itself. Associated with its broadcast information is a time stamp to indicate the temporal mark of the beginning of the transmission of information. The administrator of GPS guarantees that the clock on each satellite is synchronized with each other. Therefore, the timers of the twenty four satellites are universally consistent.

A GPS receiver generates a constantly changing code. Each satellite transmits its signal using the same codes, generated at the same time. The satellite signal is received at a later time due to the distance traveled. The receiver determines the amount of delay by delaying its own code until it matches the satellite's. The time duration for the delay is used to measure the distance. With code riding on top of the carrier signals from three different satellites, the device with the GPS receiver can identify its current location on earth. In addition to determining the location, GPS may be used in the global determination of accurate time. GPS receivers operating on known stations that provide a timing accuracy of about 0.3 microsecond with only one satellite in view.

With information from the fourth GPS satellite, the GPS receiver has enough information for the device to figure out the current actual time, which is shared by each of the twenty four satellites. The geographical information and chronicle (i.e., time) information from GPS is unique and non-repeatable within the space of earth and the period of the life span of the GPS system or any other similar systems. Thus, by utilizing these two parameters (i.e., time and location) from GPS to describe objects, uniqueness is guaranteed worldwide, and without any time limitation. It should be understood that for the purposes of this invention, GPS refers to any satellite based location system.

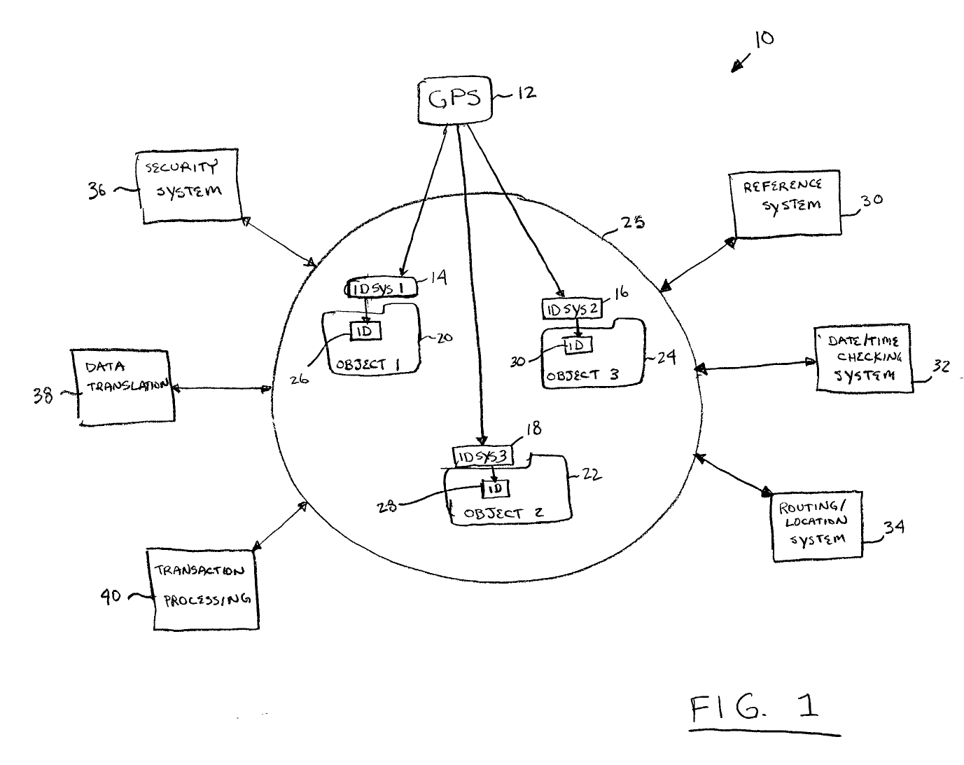

Referring now to the figures, FIG. 1 depicts an object identifier system in accordance with the present invention. Depicted is a database 25 of objects 20, 22 and 24. Database 25 may comprise any type of system for storing objects or information about objects. For example, objects 20, 22 and 24 may represent hardware devices located worldwide and database 25 may include information about each of those hardware devices. Alternatively, objects 20, 22 and 24 may comprise electronic files stored at different locations on a distributed network, accessible through one or more servers. Further, the objects may comprise transactions (e.g., electronic purchases) occurring at different locations, e.g., at different stores within a common chain of stores. As such, it should be understood that the terms database and objects should be interpreted broadly, and the examples provided herein are for exemplary purposes only and should not be limiting on the scope of the invention.

Located proximate each object is an identification system 14, 16, 18 that receives signals from GPS 12 and generates an ID 26, 28 and 30, which are directly tagged to, or indirectly associated with the respective objects. Each identification system includes a GPS receiver for determining location and time information. Specifically, the location and time information is comprised of a four dimensional grid that includes three location dimensions, and one time dimension. The time and location information is encoded into an ID in such a manner that the time and location information can be extracted from the ID if necessary. An exemplary ID could look like <X35.2;Y102.8;Z0.1;T13:59> where X, Y, and Z provide the location coordinates and T provides the time coordinate. Alternatively, the information could be encrypted using any known technique for security purposes. Accordingly, each object's ID includes four dimensional information, and each ID is unique relative to any other object's ID. Thus, ID 26 is distinguishable from ID 28, which is distinguishable from ID 30, etc.

Note that it is preferable, although not mandatory, to have each identification system located proximate the object to which an ID is being assigned. It should also be noted that there are no limitations on how each ID is tagged to, or associated with, each object. For example, the ID could be: (1) attached to a physical object (a barcode sticker on a piece of hardware); (2) stored in a database with the object; (3) stored in a database separate from the object with, for example, a pointer that points to the object, etc.

Also shown in FIG. 1 are a plurality of exemplary applications that can access database 25 and process the object ID's within database 25. For example, reference system 30 provides an application that can track events. In such an application, the objects may comprise events in a customer relations management (CRM) system that require tracking. For instance, event ID's can be used to track customer complaints received at a call center. Using ID's in this manner will, among other things, ensure that there will never be a need to recycle case numbers.

Data/time checking system 32 provides an application in which the time information can be extracted from ID's associated with each of the objects. Thus for example, if a delivery service company wanted to generate a return postage and return label for customers who might want to return packages, the date information could be used to prevent customers from using the return postage after the expiration date of accepting return packages. Alternatively, times between events could be compared and processed. For example, a vehicle traveling on a highway could be assigned an ID each time the vehicle passes predetermined points. As the vehicle passed each point, a new object could be created and stored in a database with an ID. The object could also include a photo of the vehicle, license plate data, etc. Based on information extracted from ID's of two different objects, a time and location difference can be calculated, and for instance, the speed of the vehicle could be calculated.

Routing/location system 34 could include any type of application that might need to extract location information from the objects. One such example might include the mapping of well known server or router addresses on the web. A router could use location information extracted from both its own ID and other routers' ID's to most efficiently route data and information across a network. Similarly, return addresses, or demographic information about objects could be readily determined directly from the ID.

Security system 36 could provide an application wherein ID's are utilized to, for example, prevent multiple network logins at different locations in fixed time frames. Thus, for example, a credit card holder would not be able to complete two transactions using the same credit card at two disparate locations within a short period of time. In this case, security system 36 could extract both the time and location information from ID's associated with each of the transaction events and calculate a time and location difference. If the time and location differences exceeded a threshold, a security flag could be raised.

Data translation system 38 could provide an application in which the time and location information encoded in the ID of an object could be translated into useful, i.e., human understandable, information. For example, the translated information could automatically be used for time, date and location reference in filling out forms, tables, envelopes, etc. Thus, if a police office was filling out an electronic accident report, a report object could be created with an assigned ID. The ID could be used to automatically fill in the time and location information of the report.

Transaction processing system 4.0 could be used for any system that involves transactions, including a scheme for generating temporary identifications to be used for a single, or a limited number of transactions, such as found in many online transaction processing schemes. For instance, in order to efficiently implement such a system, it is necessary to ensure that dynamically generated temporary ID's are unique, particularly in the case where there is a high volume of transactions (e.g., a telephone voucher code system that allows a user to receive free calling time by entering a code that contains an ID). The present invention ensures the necessary uniqueness, and allows transaction processing system 40 to accurately validate each transaction (e.g., ensure that a specific telephone voucher code is valid and has sufficient credit to place a call).

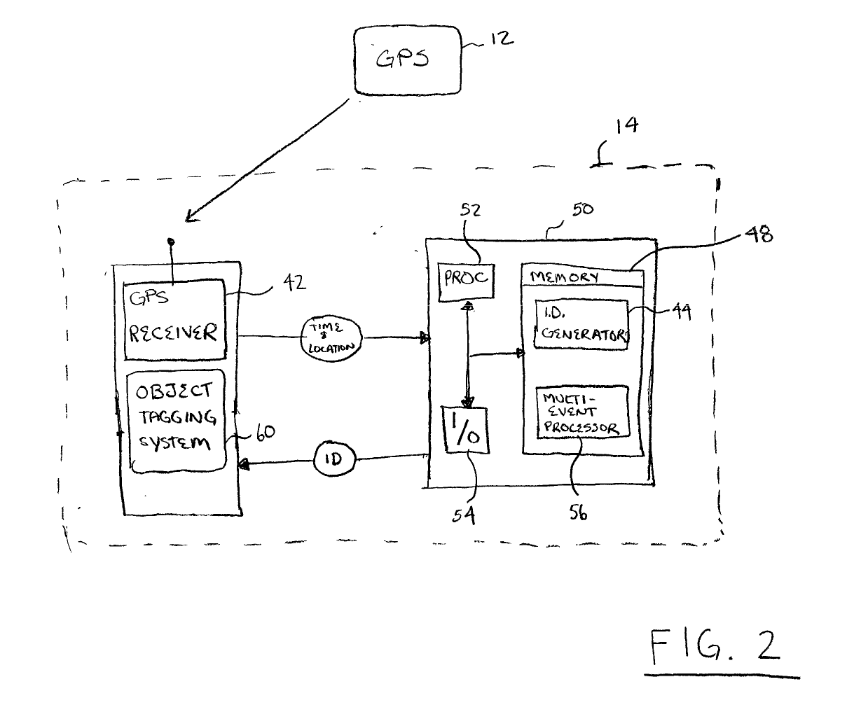

Referring now to FIG. 2, a more detailed view of ID system 14 of FIG. 1 is shown. ID system 14 provides the mechanisms for generating an ID for an object (not shown) located proximate GPS receiver 42. In operation, GPS receiver 42 receives GPS signals from GPS 12, and calculates time and location information. The time and location information is then communicated to an ID processing system 50. ID processing system 50 may include a processor 52, an input/output 54 and a memory 48. Residing in memory 48 is a software program, ID generator 44, which takes the time and location information from GPS receiver 42 and encodes it into an ID. ID processing system 50 may be physically located with the receiver, or be located remotely. For example, ID processing system 50 could be accessed over a network, such as the Internet, so that the encoding of ID's could be uniformly effectuated at a central location.

Once created, the ID is then forwarded to an object tagging system 60, which tags or associates the ID with an object. Object tagging system 60 converts the ID into a format suitable for tagging the object located proximate GPS receiver 42. For example, a tagging format may include physical in formation (e.g., a bar code ID sticker) attachable to an object; an electronic ID that can be inserted into a data record or database; or a data pointer that points to the ID; etc. Object tagging system 60 may comprise, or have access to one or more databases for storing ID and object information. In the case where a physical tag is being applied to an object, tagging is preferably done proximate GPS receiver 42, so that object's location is accurately reflected in the encoded ID. In the case where tagging involves, for example, an electronic ID stored in a database, tagging need not occur proximate the receiver. Rather, the ID can be stored, or tagged, in a remote database that includes information about the object. It should also be appreciated that object tagging system 60, as well as portions of GPS receiver 42, could exist as part of a common software program (or program product) with ID generator 44.

Also included in memory 48 is a multi-event processor 56. Multi-event processor 56 handles the case when more than one event occurs at the same location and time (i.e., a common point within the four dimensional grid). In this case, further variations of the ID would be derived by special algorithms that may, for example, read from a clock with a higher resolution to achieve the goal of assigning unique ID's to every object. Alternatively, additional data could be added to each ID to distinguish them (e.g., ID1, ID2, ID3 . . . ).

It is understood that the components of the present invention can be realized in hardware, software, or a combination of hardware and software. Any kind of computer system—or other apparatus adapted for carrying out the methods described herein—is suited. A typical combination of hardware and software could be a general purpose computer system with a computer program that, when loaded and executed, carries out the methods described herein. Alternatively, a specific use computer, containing specialized hardware for carrying out one or more of the functional tasks of the invention could be utilized. Aspects of the present invention can also be embedded in a computer program product, which comprises all the features enabling the implementation of the methods described herein, and which—when loaded in a computer system—is able to carry out these methods. Computer program, software program, program, module, mechanism or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for assigning object identifiers, comprising:
a global positioning system (GPS) receiver for providing location and time information;
an identification generator that generates an identifier, wherein the identifier includes the provided location and time information in an encoded format; and
a system for assigning the identifier to an object located proximate the GPS receiver.

2. The system of claim 1, wherein the location information includes three dimensional information.

3. The system of claim 1, wherein the object and assigned identifier are stored in a database with similar objects and their respective assigned identifiers.

4. The system of claim 1, wherein the identification generator is located remotely from the GPS receiver.

5. The system of claim 1, wherein the identification generator is located locally to the GPS receiver.

6. A program product stored on a recordable medium for assigning object identifiers, the program product comprising:
means for receiving location and time information from a global positioning system (GPS) receiver;
means for generating an identifier, wherein the identifier includes the received location and time information in an encoded format; and
means for outputting the identifier in a format suitable for tagging an object located proximate the GPS receiver.

7. The program product of claim 6, further comprising means for processing simultaneous events that occur at a common location.

8. The program product of claim 6, further comprising database means for storing the identifier.

9. A system for processing object identifiers in an e-commerce environment, comprising:
a database for holding objects;
at least one identification system for providing unique identifiers for objects, wherein the identification system obtains location and time information from a global positioning system (GPS) and encodes the location and time information into each unique identifier; and
an application for processing the objects, wherein the application includes a system for processing the unique identifier.

10. The system of claim 9, wherein the application comprises a referencing system that allows objects in the database to be tracked.

11. The system of claim 9, wherein the application comprises a time checking system that extracts time information from the unique identifiers provided to the objects.

12. The system of claim 11, wherein the objects comprise events and the time checking system compares a time difference between events.

13. The system of claim 9, wherein the application comprises a routing system that extracts location information from the unique identifiers provided to the objects.

14. The system of claim 13, wherein the objects comprise routers in a network, and the applications routes data by examining the location information associated with each router.

15. The system of claim 9, wherein the application comprises a security system.

16. The system of claim 15, wherein objects comprise login events to a computer system, and the security system ensures that each unique identifier is not afforded multiple login events.

17. The system of claim 9, wherein the application comprises a data translation system that extracts information from the unique identifier and translates it into a different format.

18. The system of claim 9, wherein the objects comprise limited use transactions, and the application validates each transaction.

19. A method of generating object identifiers, comprising the steps of:
obtaining time and location information from a global positioning system (GPS);
generating a unique identifier from the time and location information, wherein the time and location information is encoded into the unique identifier; and
associating the unique identifier with an object.

20. The method of claim 19, wherein the object exists at a time and location where the time and location information is received.

21. The method of claim 19, comprising the further step of extracting the time information from the unique identifier in order to process the object.

22. The method of claim 21, comprising the further step of comparing the time information extracted from a first and second object.

23. The method of claim 19, comprising the further step of extracting the location information from the unique identifier in order to process the object.

24. The method of claim 19, comprising the further step of tracking the object using the unique identifier.
